(19) United States
(12) Patent Application Publication
(10) Pub. No.: US 2014/0325452 A1
(43) Pub. Date: Oct. 30, 2014

(54) SMART ELECTRONIC DEVICE SHOWING VIRTUAL THREE-DIMENSIONAL USER INTERFACE AND METHOD AND SYSTEM FOR CREATING VIRTUAL THREE-DIMENSIONAL USER INTERFACE

(71) Applicant: HON HAI PRECISION INDUSTRY CO., LTD., New Taipei (TW)

(72) Inventor: MAO-YU LIN, New Taipei (TW)

(73) Assignee: HON HAI PRECISION INDUSTRY CO., LTD., New Taipei (TW)

(21) Appl. No.: 14/262,879

(22) Filed: Apr. 28, 2014

(30) Foreign Application Priority Data
Apr. 29, 2013 (TW) 102115245

(51) Int. Cl. G06F 3/0481; G06F 3/0488

(52) U.S. Cl. CPC G06F 3/04817; G06F 3/0488
USPC 715/839

(57) ABSTRACT

A method for creating a virtual three-dimensional user interface is provided. The method includes the steps. A virtual three-dimensional user interfaces is obtained and displayed. A list of the icons is obtained from the storage unit and displayed on the three-dimensional user interface. The icon displayed on the three-dimensional user interface is editable. Determine whether a certain time interval of a touch applied on a displayed icon displayed on the three-dimensional user interface arrives a predetermined time period. If so, obtaining a list of control software, selecting one of the control software and mapping a relationship between the icon and the selected control software. A system for creating a virtual three-dimensional user interface and a smart electronic device showing the virtual three-dimensional user interface are also provided.

### FIELD

The present disclosure relates to smart electronic devices and methods and systems for creating user interfaces, and more specifically to a smart electronic device showing an apparent three-dimensional user interface and a method and a system for creating such a user interface.

### BACKGROUND

Smart electronic devices (for example, smart phones) can be used to control household appliances. Control software corresponding to a specific household appliance can be installed on the smart electronic device, and icons associated with the control software can be displayed on a user interface of the smart electronic device. The icon can be clicked to activate the control software to control an associated household appliance.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 illustrates a diagrammatic view of an embodiment of a system for controlling devices.

FIG. 2 illustrates a block diagram of an embodiment of a system for creating virtual three-dimensional user interfaces.

FIG. 3 illustrates an embodiment of a virtual three-dimensional user interface.

FIG. 4 is a flowchart of an embodiment of a method for creating virtual three-dimensional user interfaces.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”. The references “a plurality of” and “a number of” mean “at least two.”

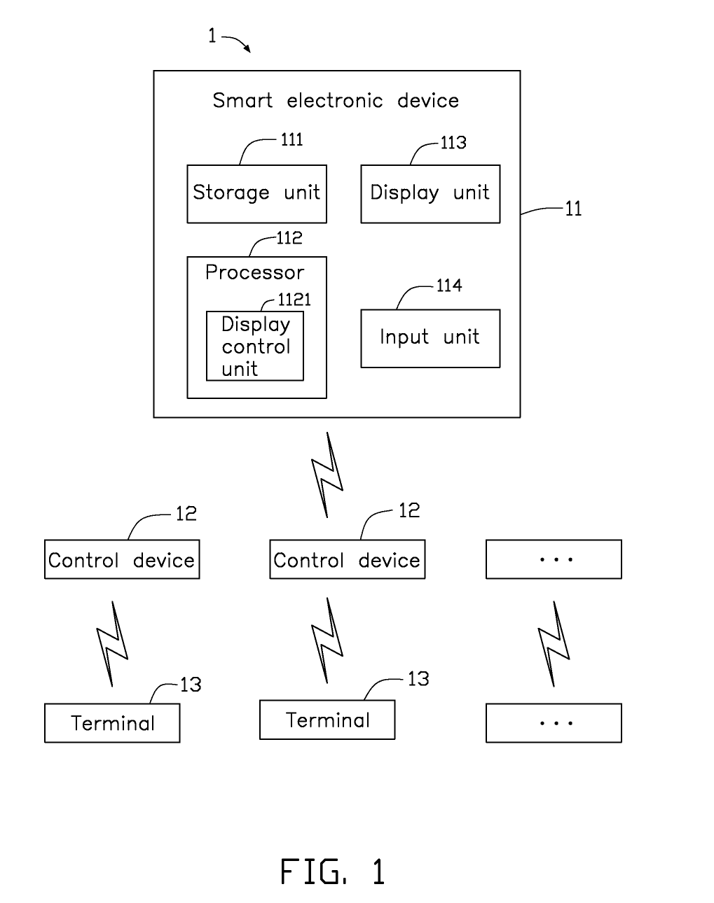

FIG. 1 illustrates an embodiment of a system 1 for controlling devices. The system 1 can include a smart electronic device 11, at least one control device 12, and at least one terminal 13. Each control device 12 corresponds to a terminal 13.

The smart electronic device 11 can be a smart phone, a tablet, personal computer, or other electronic device. The terminal 13 can be a television, a light, an air conditioner, or other appliance. The control device 12 can be on the terminal 13, or be an independent device able to control the terminal 13. The smart electronic device 11 is configured to wirelessly communicate with the control device 12. The control device 12 can communicate with the corresponding terminal 13 wirelessly or through wires.

In detail, the smart electronic device 11 can include a storage unit 111, a processor 112, a display unit 113, and an input unit 114.

The storage unit 111 stores a number of virtual three-dimensional user interfaces, a number of icons of household appliances and a number of items of control software installed on the smart electronic device 11. Each icon can be associated with one control software. The control software can control a corresponding terminal 13.

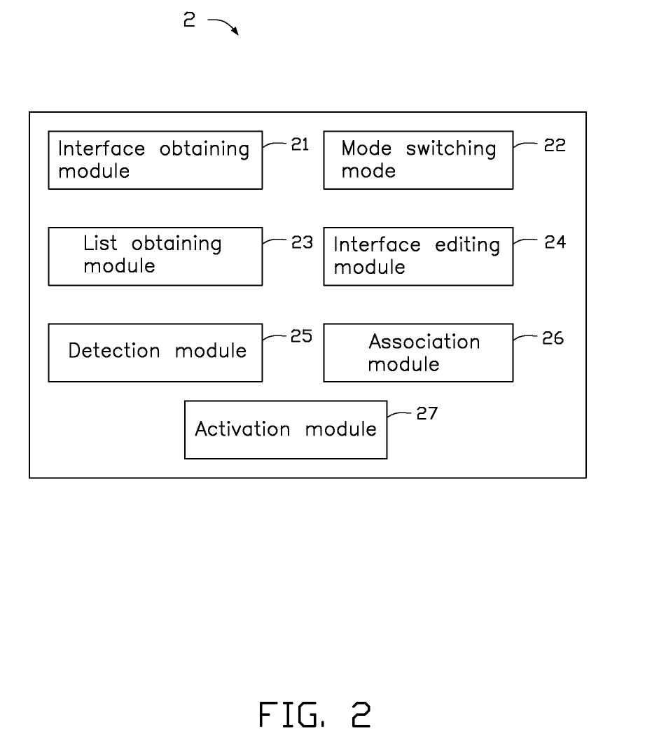

Referring to FIGS. 1 and 2, FIG. 2 illustrates an embodiment of a block diagram of a system 2 for creating virtual three-dimensional user interfaces. The system 2 is an application program which can be installed on the smart electronic device 11. The virtual three-dimensional user interface can include no icons when the system 2 is activated for the first time. The virtual three-dimensional user interface can include one or more icons added in response to user's operations via the input unit 114. In detail, the system 2 can include a number of function modules which are executable by the processor 113 of the smart electronic device 11. In the embodiment, the function modules can include an interface obtaining module 21, a mode switching mode 22, a list obtaining module 23, an interface editing module 24, a detection module 25, and an association module 26. In at least one embodiment, the function modules of the system 2 are collections of software instructions, and executed by the processor 113 of the smart electronic device 11.

The interface obtaining module 21 obtains a virtual three-dimensional user interface from the storage unit 111 when the system 2 is activated. The processor 112 can include a display control module 1121 for controlling the display unit 113 to display the obtained virtual three-dimensional user interface. The obtained virtual three-dimensional user interface has a pictorial background of a three-dimensional stereogram of a housing environment. In detail, the obtained virtual three-dimensional user interface has a pictorial background of a living room or bedroom or other room. In at least one embodiment, the pictorial background of a virtual three-dimensional stereogram of the housing environment can be changed, for example, the living room background can be changed for a bedroom background.

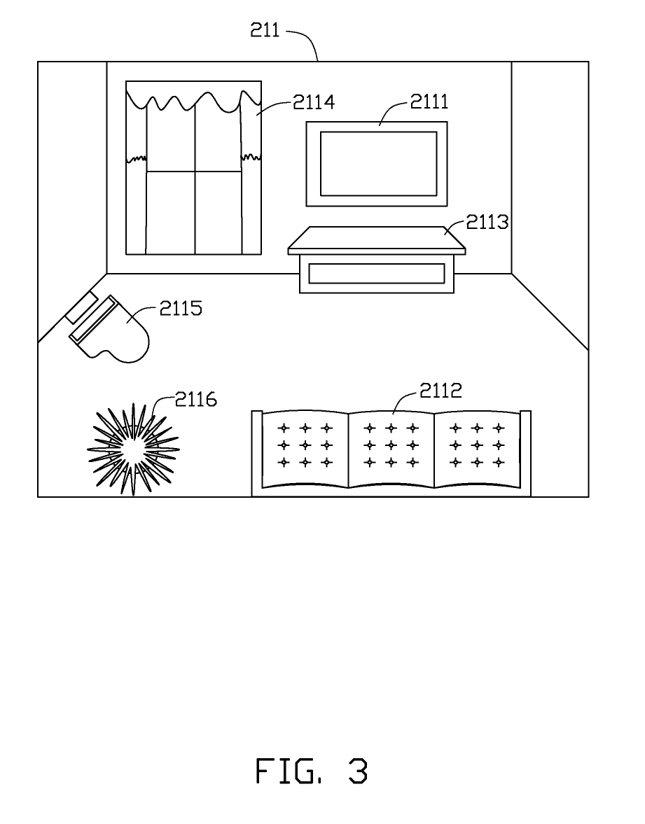

FIG. 3 illustrates a schematic diagram of an embodiment of a virtual three-dimensional user interface 211. The virtual three-dimensional user interface 211 has a background of a living room. The virtual three-dimensional user interface 211 includes a number of icons of house appliances or contents. In at least one embodiment, the virtual three-dimensional user interface 211 includes a television icon 2111, a sofa icon 2112, a television stand icon 2113, a curtain icon 2114, a piano icon 2115, and a pot culture icon 2116.

Referring to FIGS. 1-3, the smart electronic device 11 can include two operation modes. The two operation modes are normal mode and edit mode. The mode switching module 22 is used for switching operation mode of the smart electronic device 11 between the normal mode and the edit mode in response to a user's operation via the input unit 114. The mode switching module 22 also controls the smart electronic device 11 to enter the edit mode when the system 2 is activated for the first time.

When the smart electronic device 11 enters the edit mode, the list obtaining module 25 obtains a list of the icons stored in the storage unit 111, and the display control module 1121 controls the display unit 113 to display the list of the icons on the virtual three-dimensional user interface, and the interface editing module 23 edits icons displayed on the virtual three-dimensional user interface in response to user's operations via the input unit 114 and stores the edited virtual three-dimensional user interface. In at least one embodiment, the user's operations can be operations for adding icons to the virtual three-dimensional user interface, deleting icons from the virtual three-dimensional user interface, or moving icons from one position to another position on the virtual three-dimensional user interface, or other operations.

In detail, the interface editing module 23 is used for selecting an icon from the icon list in response to a user's selection operation via the input unit 114 and adding the selected icon to the virtual three-dimensional user interface 211 in response to a user's adding operation via the input unit 114. For example, the television icon 2111 can be selected from the icon list and dragged to a position as illustrated by FIG. 3. The interface editing module 23 is further used for deleting an icon from the virtual three-dimensional user interface in response to a user's deleting operation via the input unit 114. The interface editing module 23 is further used for moving an icon from one position to another position on the virtual three-dimensional user interface in response to a user's moving operation via the input unit 114.

The detection module 24 is used for detecting whether a predetermined time interval of a touch applied to an icon displayed on the virtual three-dimensional user interface has expired or is still running If the predetermined time has expired, the list obtaining module 25 obtains a list of the control software which is stored in the storage unit 111. The display control module 1121 controls the display unit 113 to display the list of the control software. In at least one embodiment, the list of the control software can include all of the control software stored in the storage unit 111. In at least one embodiment, the list of the control software can include the control software which is not associated with any icon.

The association module 26 is used for selecting one of the control software from the list of the control software from the storage unit and mapping a relationship between the selected control software and the icon in response to a user's selection operation via the input unit 114 and storing the mapping relationship in the storage unit 111.

When the smart electronic device 11 is switched into the normal mode and a displayed icon is clicked, the association module 26 is further used for determining whether the clicked icon is associated with one control software.

The function modules can further include an activation module 27 which is executable by the processor 113 of the smart electronic device 11. The activation module 27 is used for activating the control software when an association with one control software has been made with the clicked icon.

The mode switching module 22 is further used for switching the smart electronic device 11 into the edit mode when the clicked icon has not been associated with any control software. When the smart electronic device 11 is in the edit mode, the display icon can be associated with one control software as described above.

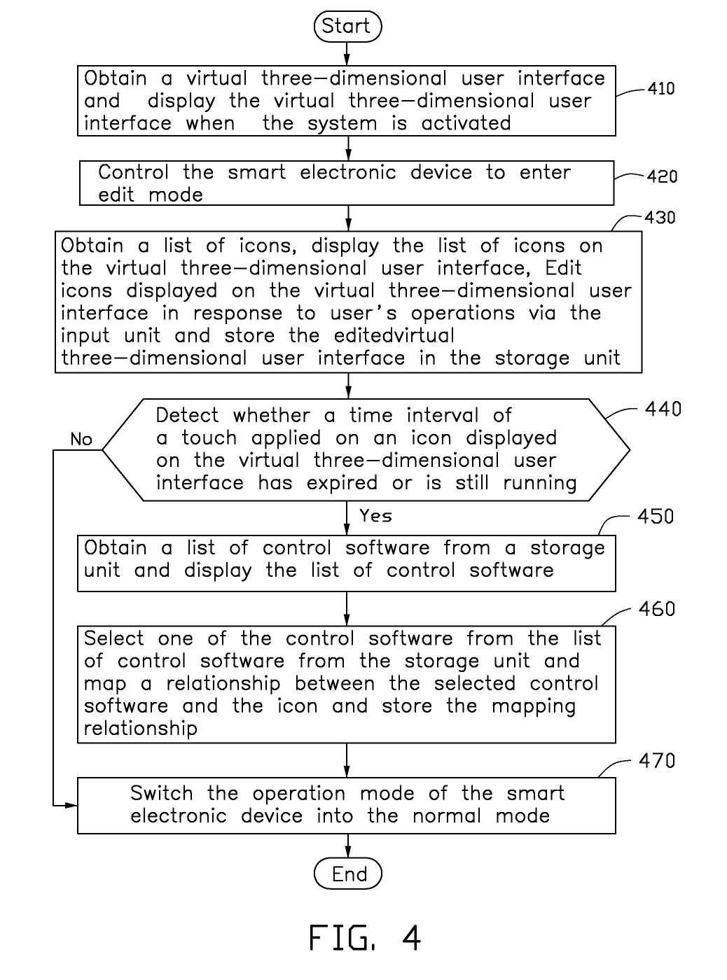

FIG. 4 is a flowchart of an embodiment of a method for creating virtual three-dimensional user interfaces.

In block 410, the interface providing module obtains a virtual three-dimensional user interface from the storage unit when the system 2 is activated, and the display control module controls the display unit to display the obtained virtual three-dimensional user interface.

In block 420, the mode switching module controls the smart electronic device to enter the edit mode. In detail, the mode switching module switches operation mode of the smart electronic device into the edit mode in response to a user's operation via the input unit when the system is activated other than for the first time and the mode switching module also controls the smart electronic device 11 enter the edit mode when the system is activated for the first time.

In block 430, the list obtaining module obtains a list of the icons stored in the storage unit, and the display control module controls the display unit to display the list of the icons on the virtual three-dimensional user interface, and the interface editing module edits icons displayed on the virtual three-dimensional user interface in response to user's operations via the input unit and stores the edited virtual three-dimensional user interface in the storage unit. The user's operations can be operations for adding icons to the virtual three-dimensional user interface, deleting icons from the virtual three-dimensional user interface, or moving icons from one position to another position on the virtual three-dimensional user interface.

In block 440, the detection module detects whether a predetermined time interval of a touch applied on an icon displayed on the virtual three-dimensional user interface has expired or is still running, if so, the process goes to 450, otherwise, the process ends.

In block 450, the list obtaining module obtains a list of the control software from the storage unit and the display control module controls the display unit to display the list of the control software.

In block 460, the association module selects one of the control software from the list of control software from the storage unit in response to a user's selection operation via the input unit and maps a relationship between the selected control software and the icon and stores the mapping relationship in the storage unit.

In block 470, the mode switching module switches the operation mode of the smart electronic device into the normal mode from the edit mode in response to a user's operation via the input unit.

Although the present disclosure has been specifically described on the basis of various embodiments thereof, the disclosure is not to be construed as being limited thereto. Various changes or modifications may be made to the embodiments without departing from the scope of the disclosure.

What is claimed is:

1. A smart electronic device showing a virtual three-dimensional user interface, the smart electronic device comprising:
a storage unit storing a plurality of virtual three-dimensional user interfaces, a plurality of icons, and a plurality of control software;
an input unit;
an interface obtaining module to obtain a virtual three-dimensional user interface from the storage unit;
a display control module to control to display the obtained virtual three-dimensional user interface;
a list obtaining module to obtain a list of icons from the storage unit, wherein the list of the icons is displayed on the virtual three-dimensional user interface;
an interface editing module to edit the icons displayed on the virtual three-dimensional user interface in response to user's operations via the input unit and store the edited virtual three-dimensional user interface;
a detection module to detect whether a time interval of a touch applied on an icon displayed on the virtual three-dimensional user interface has expired or is still running, wherein the list obtaining module is further configured to obtain a list of the control software from the storage unit when the time interval of a touch applied on an icon displayed on the virtual three-dimensional user interface has expired; and
an association module to select one of the control software from the list of the control software in response to a user's selection operation via the input unit, to map a relationship between the selected control software and the icon, and to store the mapping relationship.

2. The smart electronic device of claim 1, wherein the virtual three-dimensional user interface has a background of a virtual three-dimensional stereogram of a housing environment.

3. The smart electronic device of claim 1, further comprising a mode switching module to switch an operation mode of the smart electronic device between a normal mode and an edit mode, wherein the interface editing module edits the virtual three-dimensional user interface in response to user's operations via the input unit when the smart electronic device is controlled to enter the edit mode.

4. The smart electronic device of claim 3, wherein the interface editing module is configured to select icons from the list of the icons in response to user's selection operations via the input unit and add the selected icons to the virtual three-dimensional user interface in response to user's adding operations via the input unit.

5. The smart electronic device of claim 3, wherein the interface editing module is configured to delete the icons from the virtual three-dimensional user interface in response to a user's deleting operation via the input unit.

6. The smart electronic device of claim 3, wherein the interface editing module is configured to move the icon displayed on the virtual three-dimensional user interface from one position to another position on the virtual three-dimensional user interface in response to a user's moving operation via the input unit.

7. The smart electronic device of claim 3, wherein when the smart electronic device is switched into the normal mode, the association module is further configured to determine whether the icon clicked on is associated with one control software, and the mode switching module is further configured to switch the smart electronic device into the edit mode when the icon clicked on is not associated with the control software.

8. The smart electronic device of claim 1, wherein the icons are the icons of household appliance.

9. A method for creating virtual three-dimensional user interfaces, the method being applied on a smart electronic device having a storage unit, the method comprising:
obtaining and displaying a virtual three-dimensional user interface from the storage unit;
obtaining a list of icons of household appliance from the storage unit wherein the list of the icons is displayed on the virtual three-dimensional user interface;
editing the icons displayed on the virtual three-dimensional user interface in response to user's operations, and storing the edited virtual three-dimensional user interface;
detecting whether a time interval of a touch applied on an icon displayed on the virtual three-dimensional user interface has expired or is still running;
obtaining a list of control software wherein the list of the control software is displayed on the virtual three-dimensional user interface when a time interval of a touch applied on an icon displayed on the virtual three-dimensional user interface has expired; and
selecting control software from the list of the control software and associating the icon with the control software, and mapping a relationship between the selected control software and the icon, and storing the mapping relationship.

10. The method of claim 9, further comprising:
switching operation mode of the smart electronic device into an edit mode before obtaining a list of icons of household furnishing from the storage unit.

11. The method of claim 10, further comprising:
switching the operation mode of the smart electronic device from the edit mode into a normal mode after storing the mapping relationship.

12. The method of claim 11, further comprising:
determining whether the icon clicked on is associated with one control software;
switching the smart electronic device into the edit mode when the icon clicked on is not associated with control software.

13. A system for creating virtual three-dimensional user interfaces, the system being applied on a smart electronic device comprising a storage unit storing a plurality of virtual three-dimensional user interfaces, a plurality of icons and a plurality of control software and an input unit; the system comprising:
an interface obtaining module to obtain a virtual three-dimensional user interface from the storage unit;
a list obtaining module to obtain a list of the icons from the storage unit wherein the list of the icons is displayed on the virtual three-dimensional user interface;
an interface editing module to edit the icons displayed on the virtual three-dimensional user interface in response to user's operations via the input unit and store the edited virtual three-dimensional user interface;
a detection module to detect whether a time interval of a touch applied on an icon displayed on the virtual three-dimensional user interface has expired or is still running, wherein the list obtaining module is further configured to obtain a list of the control software from the storage unit when the time interval of a touch applied on an icon displayed on the virtual three-dimensional user interface has expired; and
an association module to select one of the control software from the list of the control software in response to a user's selection operation via the input unit and map a relationship between the selected control software and the icon and store the mapping relationship.

14. The system of claim 1, wherein the virtual three-dimensional user interface has a background of a three-dimensional stereogram of a housing environment.

15. The system of claim 13, further comprising a mode switching module to switch operation mode of the smart electronic device between a normal mode and an edit mode, and the interface editing module edits the virtual three-dimensional user interface in response to user's operations via the input unit when the smart electronic device controlled to enter the edit mode.

16. The system of claim 15, wherein the interface editing module is configured to select icons from the list of the icons in response to user's selection operations via the input unit and add the selected icons to the virtual three-dimensional user interface in response to user's adding operations via the input unit.

17. The system of claim 15, wherein the interface editing module is configured to delete the icons from the virtual three-dimensional user interface in response to a user's deleting operation via the input unit.

18. The system of claim 15, wherein the interface editing module is configured to move the icon displayed on the virtual three-dimensional user interface from one position to another position on the virtual three-dimensional user interface in response to a user's moving operation via the input unit.

19. The system of claim 15, wherein when the smart electronic device is switched into the normal mode, the association module is further configured to determine whether the icon clicked on is associated with one control software, and the mode switching module is further configured to switch the smart electronic device from the normal mode into the edit mode when the icon clicked on is not associated with the control software.

20. The system of claim 15, wherein the icons are the icons of household furnishing.
